(19) United States
(12) Patent Application Publication
(10) Pub. No.: US 2019/0331359 A1
(43) Pub. Date: Oct. 31, 2019

(54) ELECTRONIC REAL-LIFE SIMULATION TREATMENT SYSTEM

(71) Applicant: TERUMO KABUSHIKI KAISHA, Tokyo (JP)

(72) Inventors: Yuuki Sakaguchi, Isehara-shi (JP); Yuusuke Sekine, Chigasaki-shi (JP)

(21) Appl. No.: 16/506,795

(22) Filed: Jul. 9, 2019

Related U.S. Application Data
(63) Continuation of application No. PCT/JP2018/003169, filed on Jan. 31, 2018.

(30) Foreign Application Priority Data
Feb. 2, 2017 (JP) 2017-017930

(51) Int. Cl. F24F 11/64; H04N 13/363; H04N 13/194; G05B 15/02; F24F 11/65

(52) U.S. Cl. CPC F24F 11/64; H04N 13/363; F24F 11/65; G05B 15/02; H04N 13/194

(57) ABSTRACT

A medical treatment system is provided that enables a user to have an experience as if the user were in a real location that is distant from a location where the user is physically present. The electronic system comprises a spatial image acquisition unit that acquires image data from a first real space, a display unit that displays the image data in a second real space that is distant from the first real space. The electronic system comprises an audio acquisition unit, a smell acquisition unit, and an ambient air acquisition unit that acquire other sensory information different from the image data and other than visual data. An audio output unit, a smell generation unit, and an ambient air generation unit in the second real space reproduces the other sensory information acquired and, using the data and information, provides a real-life simulated output in the second real space.

### CROSS REFERENCE TO RELATED APPLICATIONS

The present application is a continuation of and claims benefit to PCT Application No. PCT/JP2018/003169, filed on Jan. 31, 2018, entitled “ELECTRONIC SYSTEM” which claims priority to Japanese Patent Application No. 2017-017930, filed on Feb. 2, 2017. The entire disclosures of the applications listed above are hereby incorporated herein by reference, in their entirety, for all that they teach and for all purposes.

### FIELD

The present disclosure is generally directed to an electronic system and, in particular, toward an electronic real-life simulation treatment system.

### BACKGROUND

In recent years, development of a technique, called virtual reality (VR), of displaying a space that does not really exist by a computer graphic technique has been progressed. The use of the abovementioned VR technique enables a user to feel a sense as if the user experienced a specified act without having actually experienced it. Some techniques related to the VR technique are described in Japanese Patent Application JP-A-2002-101429, which provides a stereoscopic image projector that projects a three-dimensional shape from light sources that are placed at proper positions of a ceiling of a room into a space.

### SUMMARY

### Technical Problem

However, as generally provided in Japanese Patent Application JP-A-2002-101429, although a virtual space (e.g., a space that is not real) may be displayed by the virtual space generator, the virtual space generator does not allow a user to have an experience as if the user was physically present in a real location.

When a person becomes ill, or is otherwise unable to travel or be around their family members, the person, being physically isolated, may begin to feel alone. As can be appreciated, this feeling of loneliness may result in sadness or depression, which can adversely affect a medical treatment, healing time, or general comfort of the person. Therefore, it is an object of the present disclosure to provide an electronic system that enables a user to have an experience as if the user were in a real location that is distant from a location where the user is physically present.

### Solution to the Problem

An electronic system according to the present disclosure that attains the abovementioned object includes: a spatial image acquisition unit that acquires a first real spatial image that is visually perceived in a predetermined first real space; a display unit that virtually displays the first real spatial image acquired by the spatial image acquisition unit, in a second real space that is distant from the first real space; a spatial information acquisition unit that acquires first real spatial information that is different from the first real spatial image and perceived by any of five senses other than vision (e.g., hearing, smell, touch, and taste), in the first real space; and a reproduction unit that reproduces the first real spatial information acquired by the spatial information acquisition unit, in the second real space.

An electronic real-life simulation treatment system is provided, comprising: a camera disposed in a first real space, wherein the camera acquires video data about an environment of the first real space; a spatial information acquisition unit disposed in the first real space, the spatial information acquisition unit comprising: a microphone that detects sounds in the environment of the first real space; an electronic odor sensor that detects scents in the environment of the first real space; and an ambient air acquisition unit that measures ambient air conditions in the environment of the first real space comprising at least one of a temperature, a wind velocity, and a humidity; and a communication unit that sends, across a communication network, the video data and information about the detected sounds, the detected scents, and the ambient air conditions in the environment of the first real space to a receiving communication unit in a second real space that is different and remotely located from the first real space, wherein, in response to receiving the video data and information a display unit disposed in the second real space is caused to output the video data and a reproduction unit disposed in the second real space is caused to reproduce the detected sounds, the detected scents, and the ambient air conditions in an environment of the second real space.

A method is provided, comprising: acquiring, via a camera disposed in a first real space, a first real spatial image of an area of the first real space, wherein the first real spatial image comprises video data; transmitting, across a communication network via a communication unit, the first real spatial image to a receiving communication unit in a second real space, wherein the second real space is different and remotely located from the first real space; displaying, via an image projector disposed in the second real space, the first real spatial image to a surface in the second real space as the first real spatial image is received from the communication unit; acquiring, via a spatial information acquisition unit disposed in the first real space, first real spatial information comprising sound data and at least one of odor data, temperature data, and wind speed data measured in the first real space; transmitting, across the communication network via the communication unit, the first real spatial information to the receiving communication unit in the second real space; and outputting, in response to receiving the first real spatial information, the sound data via a speaker disposed in the second real space and at least one of a reproduced odor in the second real space based on the odor data, a reproduced temperature in the second real space based on the temperature data, and a reproduced air output in the second real space based on the wind speed data.

The electronic system and methods according to the present may be configured as described above, so that a user (e.g., a patient or other person, etc.) can have an experience as if the user were in a real location that is distant from a location where the user is physical present.

### BRIEF DESCRIPTION OF THE DRAWINGS

FIG. 1 is a diagram illustrating an electronic real-life simulation treatment system in a healing-space location where a user is physically present in accordance with embodiments of the present disclosure.

FIG. 2 is a diagram illustrating an electronic real-life simulation treatment system in a real space location that is distant from the healing-space location where the user is physically present in accordance with embodiments of the present disclosure.

FIG. 3 is a diagram illustrating a state where the electronic real-life simulation treatment system displays the real-space location that is distant from the healing-space location where the user is physically present on a wall, partition, or other surface in the healing-space location shown in FIG. 1.

FIG. 4 is a block diagram illustrating the components associated with the electronic real-life simulation treatment system according to a first embodiment of the present disclosure.

FIG. 5 is a sequence diagram illustrating exchanges of information in the electronic real-life simulation treatment system in accordance with embodiments of the present disclosure.

FIG. 6 is a flowchart illustrating a method of exchanging information between components of the electronic real-life simulation treatment system in accordance with embodiments of the present disclosure.

FIG. 7 is a diagram illustrating an electronic real-life simulation treatment system in a healing-space location where a user is physically present in accordance with embodiments of the present disclosure.

FIG. 8 is a block diagram illustrating the components associated with the electronic real-life simulation treatment system according to a second embodiment of the present disclosure.

FIG. 9 is a diagram illustrating an electronic real-life simulation treatment system in a healing-space location where a user is physically present in accordance with embodiments of the present disclosure.

FIG. 10 is a block diagram illustrating the components associated with the electronic real-life treatment system according to a third embodiment of the present disclosure.

FIG. 11 is a diagram of the electronic real-life treatment system where an unmanned aerial vehicle is used for transmission and reception of data between components of the real-space location and the healing-space location according to an embodiment of the present disclosure.

FIG. 12 is a schematic diagram illustrating the unmanned aerial vehicle of FIG. 11.

FIG. 13 is a diagram illustrating an electronic real-life simulation treatment system where a portable device is used to display a spatial image from a remote location with respect to a user in a healing-space location in accordance with embodiments of the present disclosure.

### DETAILED DESCRIPTION

Hereinafter, embodiments according to the present disclosure will be described with reference to the attached drawings. Note that the following description does not limit the technical scope described in the claims and the meaning of terms. Moreover, the size ratios in the drawings may be exaggerated for convenience of explanation and may be different from the actual ratios in some cases.

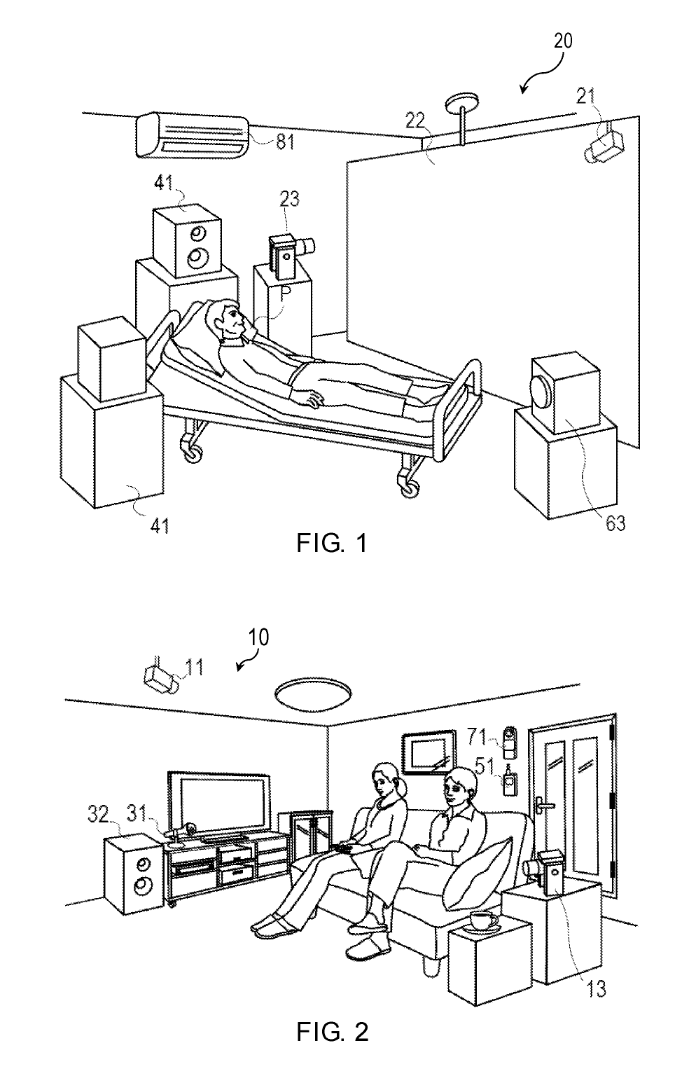

FIG. 1 to FIG. 6 are diagrams that are provided for an explanation of an electronic real-life simulation treatment system (“electronic system”) according to a first embodiment of the present disclosure. Embodiments of the electronic system 100 described herein may correspond to a medical treatment system that can be used when a patient (user) in hospitalization desires to have an experience as if the patient visited a location where the patient was supposed to attend if the patient had not been hospitalized.

The electronic system 100 may include components that are associated with a healing-space location and a remotely located real-space location. The healing-space location may correspond to a real and physical location where a physically present user is hospitalized, undergoing medical treatment, placed under supervised care, and/or otherwise healing. The real-space location may correspond to a real and physical location that is remote from the healing-space location, where the user is not physically present (e.g., a vacation destination, a home, a workplace, etc.) The electronic system 100 may include a spatial image acquisition unit 10 and a spatial information acquisition unit disposed in the real-space location (shown in FIG. 2) remote from the healing-space location and the user physically present in the healing-space location. The electronic system 100 may include a display unit 20 and a reproduction unit disposed in the healing-space location (shown in FIG. 1). In some embodiments, the spatial image acquisition unit 10 acquires a first real spatial image that is visually perceived in a predetermined first real space (e.g., the real-space location). The display unit 20 can then virtually display the first real spatial image acquired by the spatial image acquisition unit 10, in a second real space (e.g., the healing-space location) that is distant from the first real space. The spatial information acquisition unit may include an audio acquisition unit 30, a smell (e.g., scent) acquisition unit 50, and an ambient air acquisition unit 70, and acquires first real spatial information that is different from the first real spatial image and perceived by any of five senses other than vision (e.g., taste, touch, smell, and hearing) in the first real space. The reproduction unit may include an audio output unit 40, a smell (e.g., scent) generation unit 60, and an ambient air generation unit 80, and reproduces the first real spatial information acquired by the spatial information acquisition unit in the second real space.

Note that, a case where the first real space corresponds to a house of a relative of a patient P as illustrated in FIG. 2, and a case where the second real space is a sickroom (e.g., in a hospital, etc.) of the patient P as illustrated in FIG. 1 will be described below. However, as long as an environment allows the electronic system 100 described below to be installed, the locations of the first real space and the second real space are not limited to the house and the hospital, respectively. Additionally or alternatively, any two locations selected from a care facility, a nursery school (day nursery), a wedding center, a resort in a travel destination that is originally scheduled to be visited, and the like, and conference rooms distant from each other may be used. Hereinafter, a detailed explanation will be made.

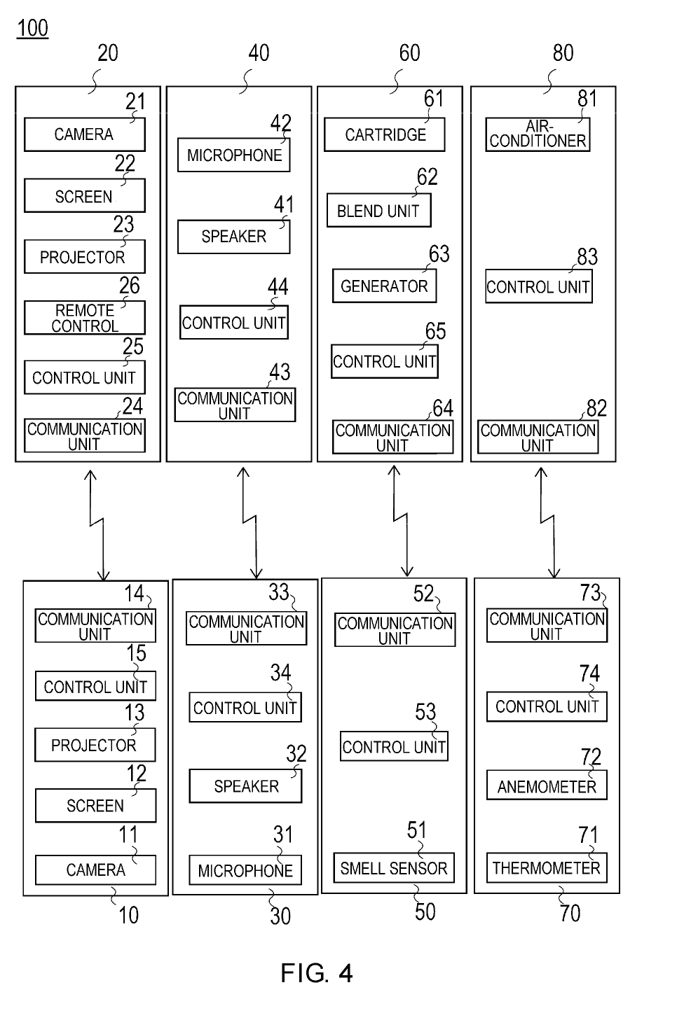

The spatial image acquisition unit 10 may include, as illustrated in FIG. 4, a camera 11, a screen 12, a projector 13, a communication unit 14, and a control unit 15. As illustrated in FIG. 2, the camera 11 is installed in a room of a house (e.g., the real-space location) where a relative and others who perform communication (mutual understanding) with the patient P. The camera 11 may acquire a spatial image of the relative and others in the room. Here, in the present description, the spatial image may correspond to an image or a video.

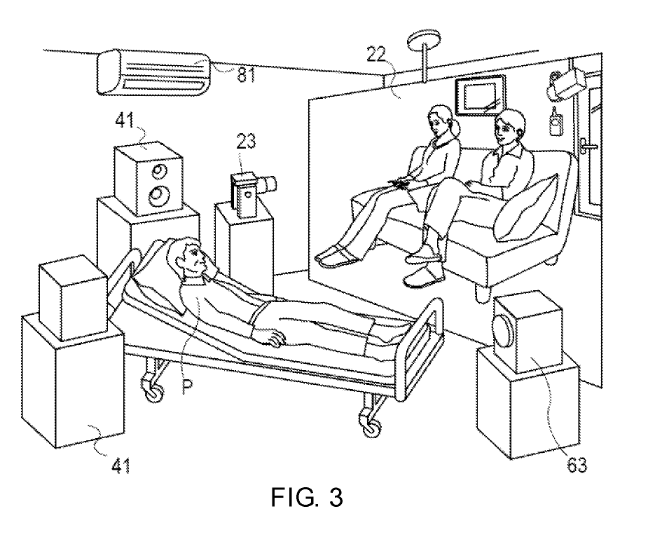

The screen 12 is provided so as to cause a video that is projected by the projector 13 to be rendered to or otherwise displayed thereon. As illustrated in FIG. 3, the projector 13 may display a video using a technique of so-called projection mapping to an area, surface, or number of surfaces, in the room. In one embodiment, the screen 12 is configured to be installed in the room where the relative is physically present. However, the embodiments described herein are not so limited. Although not shown in FIG. 2, the screen 12 may correspond to a surface (e.g., a wall surface) in the room where the relative and others are physically present. In some embodiments, the screen 12 may correspond to a television screen, computer monitor, and/or the like. In one embodiment, the screen 12 may have a human shape, or other shape upon which an image, or images, may be displayed. In any event, the screen 12 in the real-space location may display images acquired by the camera 21 in the healing-space location. In this manner, the family members may be able to see and interact with the user in the healing-space location while remaining remotely located in the real-space location (i.e., not physically present in the healing-space location). Note that, the manner of projection of a spatial image described in conjunction with FIG. 2 (e.g., by the projector 13 onto a screen 12, etc.) may be similar, if not identical, to that in FIG. 3 (e.g., by the projector 21 onto the screen 22), and thus further description thereof is omitted.

As for the projector 13, a liquid crystal type projector, a digital light processing (DLP) projector, a liquid crystal on silicon (LCOS) display projector, etc., or other display device.

The communication unit 14 may include hardware or the like that enables wireless communication, and that is capable of transmitting and receiving data, such as a video, for performing an exchange of communication between the patient P in the healing-space location and one or more relatives and others who may be present in a distant location (e.g., the real-space location), using the Internet, other communication channels, a communication network and/or the like. The control unit 15 may comprise a central processing unit (CPU) or other processor, a random-access memory (RAM), a read-only memory (ROM), and/or the like, and may control the communication unit 14, the camera 11, and/or other components of the spatial acquisition unit 10. The control unit 15 may comprise the ROM on which a program necessary for projection mapping is recorded or stored, and may correct or alter a video photographed by a camera 21 of the display unit 20 in accordance with a shape or the like of the screen 12. Among other things, this ability enables a video acquired (e.g., by the camera 21) in the hospital (e.g., healing-space location) where the patient P is physically present to be rendered, in the real-space location where the relatives and/or others may be physically present, in accordance with the shape of the screen 12.

The display unit 20 may include, as illustrated in FIG. 4, the camera 21, a screen 22, a projector 23, a communication unit 24, a control unit 25, and a remote control 26. The camera 21 may correspond to any type of camera, image sensor, or other imaging system capable of acquiring still and/or moving images. In some embodiments, the camera 21 may be substantially similar, if not identical, to the camera 11, and may acquire an image in a range of the patient P, and/or an area surrounding the patient, etc., inside the room (e.g., the healing-space location) of the patient P.

As illustrated in FIGS. 1 and 3, the screen 22 may be installed inside the room where the patient P is physically present similar to the screen 12. In some embodiments, the screen 22 may be substantially planar, or flat, having no pattern or the like. In some embodiments, the screen 22 may have slight irregularities or be formed with patterns. As provided herein, the screen 22 may correspond to the projection unit having a projection surface.

The projector 23 may be substantially similar, if not identical, to the projector 13 previously described and, as such, a detailed explanation thereof is thus omitted. Note that, the projector 23 may correspond to the video output unit that projects a video of the house corresponding to the first real space in the present description.

The communication unit 24 may include hardware or the like that is substantially similar, if not identical, to that of the communication unit 14 described above, and may be configured to receive video data transmitted across a communication network from a distant location, such as the house. In some embodiments, the communication unit 24 may be configured to transmit video (e.g., acquired by the camera 21 in the healing-space location) to the distant location (e.g., the real-space location), such as the house across a communication network. The control unit 25 may include a CPU, a RAM, a ROM, and the like, and controls the projector 23 and the communication unit 24. The control unit 25 may comprise a stored program necessary for projection mapping on the ROM thereof similar to the control unit 15, and corrects a video acquired from the spatial image acquisition unit 10 in accordance with a shape or the like of the screen 22.

The program for projection mapping stored in the ROM of the control unit 25 may correspond to the correction unit that corrects a video in accordance with properties of the projection surface in the present description. The remote control 26, may comprise a number of buttons, a communication unit, and other components, and may be configured to send a control signal (e.g., a wired or wireless signal) that switches a functionality of the display unit (e.g., turns on and off features, activates features, and/or otherwise controls one or more components associated with the display unit 20).

The audio acquisition unit 30 may include, as illustrated in FIG. 4, a microphone 31, a speaker 32, a communication unit 33, and a control unit 34. The microphone 31 may be installed, as illustrated in FIG. 2, in one room in the house of the relative and others, and detects or acquires sounds uttered or emitted by the relative and/or others and an ambient sound (e.g., other sounds in the room, environmental sounds around the relative and/or others, etc.). The speaker 32 may be installed in one room in the house of the relative and others, and outputs the sounds of the patient P and/or from an area surrounding the patient P that may be acquired in the hospital (e.g., the healing-space location) that is remote from the house (e.g., the real-space location).

The communication unit 33 may be configured similar, if not identical, to the communication unit 14 described above, and transmits the sound of the relatives etc. to the hospital and receives sounds of the patient P (e.g., patient P sounds, environmental sounds proximal to the patient P, etc.) transmitted from the hospital, or the like, where the patient P is physically present. The control unit 34 may include a CPU, a RAM, a ROM, and the like, and may control the various components, or units, of the audio acquisition unit 30 including the communication unit 33, the speaker 32, and the microphone 31.

The audio output unit 40 may include, as illustrated in FIG. 4, one or more speakers 41, a microphone 42, a communication unit 43, and a control unit 44. The speakers 41 may be installed, or otherwise disposed, in the sickroom where the patient P is physically present, and output the sounds of the relative and others and/or the ambient sound transmitted from the communication unit 33. The microphone 42 may be installed in one room in the hospital where the patient P is physically present, and acquires a sound uttered by the patient P and an ambient sound (e.g., other sounds in the room of the hospital, environmental sounds around the patient, etc.).

The communication unit 43 substantially similar, if not identical, to the communication unit 14 described above, and transmits and receives data related to the sound to and from the communication unit 33. The control unit 44 may include a CPU, a RAM, a ROM, and the like, and may control the communication unit 43, the speakers 41, the microphone 42, and/or other components of the audio output unit 40.

The smell acquisition unit 50 may include, as illustrated in FIG. 4, a smell, or scent, sensor 51, a communication unit 52, and a control unit 53. The smell sensor 51 corresponds to the detection unit that detects a smell, or scent, inside the room of the house that corresponds to the first real space such as the house where the relatives are present, as illustrated in FIG. 2. A plurality of the smell sensors 51 can be installed in accordance with one or more predetermined smells to be acquired. The smell sensors 51 may include, but are in no way limited to, one or more of an electronic nose, a chemosensor, a gas chromatography instrument, and/or other instrument, sensor, or combination of sensors that are tuned to electronically detect a particular odor, compare the composition of the odor to known patterns for specific smells, and then identify the odor detected.

The smell sensor 51 can be installed in accordance with a location having the electronic system 100, for example, a sensor that detects a smell of coffee, tea, or the like and a sensor that detects a smell of furniture in a living room or a bedroom. Note that, in FIG. 2, as one example, a cup of coffee or the like is prepared in the room where the relative and others are present. The smell sensor 51 may be tuned, or otherwise trained, to detect or sense the presence of coffee in the room based on odors emitted from the cup of coffee. Each scent may have its own unique odor pattern or characteristics that allow the smell sensor 51 to differentiate between various smells in the room.

The communication unit 52 may comprise hardware similar to that of the communication unit 14 described above, and transmits information related to the smell acquired by the smell sensor 51 (e.g., across a communication network) to the smell generation unit 60. The control unit 53 may control the smell sensor 51 and the communication unit 52.

The smell generation unit 60 may include, as illustrated in FIG. 4, a cartridge 61, a blend unit 62, a generator 63, a communication unit 64, and a control unit 65. in some embodiments, a plurality of cartridges 61 may be included, for example, which contain a smell of food and drink and a smell like furniture, respectively, in order to reproduce the smell of the room where, for example, a relative who has a conversation with the patient P is physically present.

The blend unit 62 blends a plurality of smells that are contained in the cartridges 61 in order to reproduce the smell substantially similar to that in the actual house on the basis of information acquired from the communication unit 64 (e.g., provided via the smell sensor 51). The generator 63 includes a fan, or other air movement device, and blows or otherwise emits the smells blended by the blend unit 62 in a direction toward the patient P or into the atmosphere around the patient. The communication unit 64 communicates with the communication unit 52 of the smell acquisition unit 50 in a distant location, and acquires data related to smell components measured by the smell acquisition unit 50. The control unit 65 may include a CPU, a RAM, a ROM, and the like, and may control the units of the smell generation unit 60 from the blend unit 62 to the communication unit 64.

The ambient air acquisition unit 70 may include, as illustrated in FIG. 4, a thermometer 71, an anemometer 72, a communication unit 73, and a control unit 74. The thermometer 71 may include, but is in no way limited to, a digital thermometer, a thermocouple, thermistor, pyrometer, an infrared thermometer, and/or the like. As illustrated in FIG. 2, the thermometer 71 (e.g., mounted to a wall, etc.) may acquire, as digital data, the temperature in a room in a house where the relative and others are present. The anemometer 72 may include, but is in no way limited to, a cup anemometer, a laser Doppler anemometer, a sonic anemometer, an ultrasonic anemometer, a vane anemometer, an ultrasonic anemometer, and/or any other device that is configured to measure the wind velocity, or current of a gas, or the like in the room in the house where the relative and others are present. The use of the thermometer 71 and the anemometer 72 together allows the temperature and the wind in a space where the patient P is physically present (e.g., the healing-space location) to be adjusted similarly to those in the room where the relative and others are physically present (e.g., the real-space location), for example, when the temperature inside the room where the relative is physically present is adjusted using an air-conditioner or the like. As can be appreciated, adjusting the temperature using an air-conditioner causes conditioned air to be output into the room, which may alter the wind velocity in the room. The information from the thermometer 71 and the anemometer 72 detecting this change in temperature and wind velocity, respectively, may be provided to an air conditioner 81 in the room of the patient P, and the wind and temperature can be matched to that of the room where the relative and others are physically present.

The thermometer 71 may correspond to the measurement unit that measures an ambient temperature inside the room where the relative and others are physically present in the house that corresponds to the first real space in the present description. The anemometer 72 may correspond to the different measurement unit that measures a wind velocity inside the room where the relative and others are present and that corresponds to the first real space.

The communication unit 73 transmits data acquired by the thermometer 71 and the anemometer 72 to a communication unit 82 of the ambient air generation unit 80 of the patient P. The control unit 74 may include, similar to the control units described above, a CPU, a RAM, a ROM, and the like, and may control the units of the ambient air acquisition unit 70 including, but not limited to, the thermometer 71, the anemometer, and the communication unit 73.

The ambient air generation unit 80 may include, as illustrated in FIG. 4, an air-conditioner 81, the communication unit 82, and a control unit 83. The air-conditioner 81 can include a fan, a compressor, an evaporator, a condenser, an expansion valve, and/or the like, and adjusts the temperature and the wind velocity inside the room where the patient P is physically present. The air-conditioner 81 may correspond to the adjustment unit that adjusts the temperature in a certain room in the hospital where the patient P is physically present in accordance with the temperature measured by the thermometer 71, and that corresponds to the second real space, in the present description. Moreover, a fan and/or other component of the air-conditioner 81 may correspond to the blowing unit that outputs air at the wind velocity measured by the anemometer 72 in the second real space.

The communication unit 82 receives data related to the temperature and the wind velocity in the room where the relative and others are physically present from the communication unit 73 of the ambient air acquisition unit 70. The control unit 83 controls the air-conditioner 81 and the communication unit 82. In some embodiments, the control unit 83 may control an output of the air-conditioner 81 based on the data (e.g., related to the temperature and the wind velocity in the room where the relative and others are physically present) received from the communication unit 73 of the ambient air acquisition unit 70.

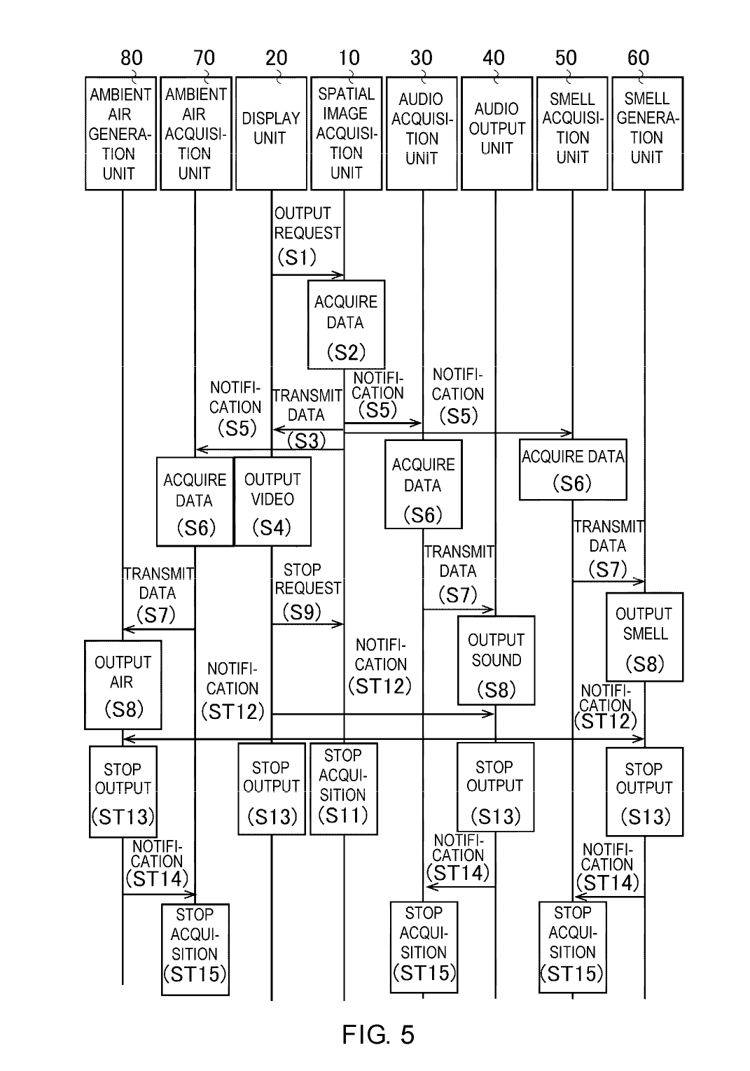

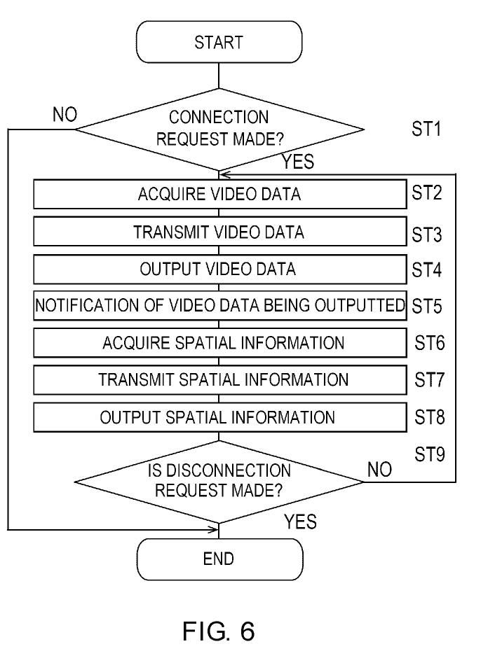

Next, communications between distant locations using the electronic system 100 according to embodiments of the present disclosure will be described. FIG. 5 is a sequence diagram illustrating exchanges of information in the electronic system 100 according to embodiments of the present disclosure. FIG. 6 is a flowchart illustrating a method of exchanging information between components of the electronic system 100 in remote locations in accordance with embodiments of the present disclosure.

As shown in FIG. 6, the method begins by making a determination whether the patient P requests a connection to a house that is a remote location by, for example, pressing down a button on the remote control 26 (ST1). If the connection request is made (ST1: YES), the camera 11 of the spatial image acquisition unit 10 acquires a video within an image pickup range on the part of the house (ST2). Next, acquired video data is then transmitted, via the communication units 14 and 24, to the part of a hospital where the patient P is physically present (ST3). The projector 23 of the display unit 20 projects the video data onto the screen 22, and the patient P becomes capable of visually identifying the video (ST4). It is an aspect of the present disclosure that the video data is displayed to the patient P via the display unit 20 in real time (e.g., as it is acquired by the camera 11 in the remotely located house).

Moreover, when the spatial image acquisition unit 10 transmits the video data, the communication unit 14 notifies the audio acquisition unit 30, the smell acquisition unit 50, and the ambient air acquisition unit 70 of an output request of the video data having been made (ST5). When the abovementioned notification is made in the audio acquisition unit 30, the smell acquisition unit 50, and the ambient air acquisition unit 70, the audio acquisition unit 30, the smell acquisition unit 50, and the ambient air acquisition unit 70 acquire data on a sound, a smell, and a temperature and a wind velocity of the surrounding, respectively, within approximately the same range as that of the spatial image acquisition unit 10 (ST6).

The communication units 33, 52, and 73 transmit the data respectively acquired by the audio acquisition unit 30, the smell acquisition unit 50, and the ambient air acquisition unit 70 to the communication units 43, 64, and 82 (ST7). The speakers 41 of the audio output unit 40, the generator 63 of the smell generation unit 60, and the air-conditioner 81 of the ambient air generation unit 80 respectively output the transmitted spatial information in the surrounding of the patient P (ST8). The processes from acquisition of video data at ST2 to the output of spatial information at ST8 in FIG. 6 are continued unless and until a disconnection request for the connection to the house that corresponds to the first real space is made, for example, from the remote control 26 of the patient P (ST9: NO).

Unless the patient P makes a disconnection request for the connection to the house by the remote control 26, the relative can have an interactive conversation with the patient P using the camera 11, the screen 12, the projector 13, the microphone 31, and the speaker 32.

If the patient P makes a disconnection request for the connection to the house by the remote control 26 (ST9: YES), the outputs of the spatial image and the spatial information from the display unit 20, the audio output unit 40, the smell generation unit 60, and the ambient air generation unit 80 are stopped.

Next, exchanges of information in the abovementioned electronic system 100 will be described with reference to FIG. 5.

In the electronic system 100, when the patient P presses down a particular button on the remote control 26, the control unit 25 of the display unit 20 causes the communication unit 24 to transmit a signal requesting an output of video data to the communication unit 14 of the spatial image acquisition unit 10 (S1). When receiving the signal, the communication unit 14 of the spatial image acquisition unit 10 causes the camera 11 to operate and pick up a relative who is physically present within an image pickup range of the camera 11 and a background in the surrounding, and acquires video data (S2).

The communication unit 14 subsequently transmits the video data picked up by the camera 11 to the communication unit 24 of the display unit 20 (S3). When the communication unit 24 of the display unit 20 acquires the video data, the projector 23 outputs the video of the house on the screen 22 as illustrated in FIG. 3 (S4). Moreover, the communication unit 14 of the spatial image acquisition unit 10 respectively transmits signals notifying that an output request is made when the signal has been received, to the communication unit 33 of the audio acquisition unit 30, the communication unit 52 of the smell acquisition unit 50, and the communication unit 73 of the ambient air acquisition unit 70 (S5).

When the communication unit 33 of the audio acquisition unit 30 receives the signal from the communication unit 14, the control unit 34 controls the microphone 31 to acquire a sound of the relative who is physically present in a range of several meters around, that is an acquisition region, and an ambient sound (S6). Sound data acquired by the microphone 31 is then transmitted via the communication unit 33 to the communication unit 43 of the audio output unit 40 (S7), and the speakers 41 output the transmitted sound data toward the patient P (S8).

Meanwhile, when the communication unit 52 of the smell acquisition unit 50 receives the signal from the communication unit 14, the smell sensor 51 acquires smell data in a range of several meters around (S6). The acquired data is transmitted via the communication unit 52 to the communication unit 64 of the smell generation unit 60 (S7). As for the data received by the communication unit 64, the control unit 65 selects necessary smell components from the cartridge 61, and the blend unit 62 blends the necessary smell components, which are to be output in the surrounding of the patient P (S8).

When the communication unit 73 of the ambient air acquisition unit 70 receives the signal from the communication unit 14, the control unit 74 activates the thermometer 71 and the anemometer 72, which respectively measure a temperature and a wind velocity within a range of several meters around (S6). The communication unit 73 transmits the data respectively measured by the thermometer 71 and the anemometer 72 to the communication unit 82 of the ambient air generation unit 80 (S7). The air-conditioner 81 of the ambient air generation unit 80 adjusts the temperature and the wind velocity inside the room where the patient P is physically present on the basis of the received information (S8).

On the other hand, if the patient P requests for a disconnection of the connection to the house that is a distant location, the patient P presses down the button on the remote control 26 of the display unit 20 (S9). When the button on the remote control 26 is pressed down, in the display unit 20, the control unit 25 stops an output of the projector 23, and stops the projection of the video onto the screen 22 (S10). When the communication unit 14 receives the signal from the communication unit 24, the control unit 15 stops the acquisition of video data by the camera 11 (S11).

Moreover, when the button on the remote control 26 is pressed down, the communication unit 24 notifies the communication units 43, 64, and 73 of output stop signals having been transmitted (S12). When the communication unit 43 receives the signal, the control unit 44 stops the output of the sounds (S13). Moreover, when the communication unit 64 receives the signal from the communication unit 14, the control unit 65 stops the operations of the blend unit 62 and the generator 63 (S13). When the communication unit 82 receives the signal from the communication unit 14, the control unit 83 stops the operation of the air-conditioner (S13).

When the communication unit 43 receives the signal from the communication unit 24, the communication unit 43 notifies the communication unit 33 of an acquisition stop request of sound data (S14). The control unit 34 controls the microphone 31 to stop the acquisition of sound data inside the room of the house (S15).

When the communication unit 64 receives the signal from the communication unit 24, the communication unit 64 notifies the communication unit 52 of an acquisition stop request of smell data (S14). In response to this notification, the control unit 53 stops the operation of the smell sensor (S15).

When the communication unit 82 receives the signal from the communication unit 24, the communication unit 82 notifies the communication unit 73 of an acquisition stop request of ambient air data (S14). In response to this notification, the control unit 74 stops the acquisition of temperature data by the thermometer 71 and wind velocity data by the anemometer 72 (S15).

As in the foregoing, the electronic system 100 according to embodiments of the present disclosure may be configured to include the spatial image acquisition unit 10, the display unit 20, the spatial information acquisition unit, and the reproduction unit. The spatial image acquisition unit 10 acquires a spatial image that is visually perceived in a house that corresponds to a predetermined first real space. The display unit 20 virtually displays the first real spatial image acquired by the spatial image acquisition unit 10 in a hospital that is a second real space distant from the house that is the first real space.

The spatial information acquisition unit includes the audio acquisition unit 30, the smell acquisition unit 50, and the ambient air acquisition unit 70, and acquires spatial information that is different from the first real spatial image and perceived by any of five senses other than vision in the house, which corresponds to the first real space. The reproduction unit includes the audio output unit 40, the smell generation unit 60, and the ambient air generation unit 80, and reproduces the first real spatial information on the house that is the first real spatial information acquired by the spatial information acquisition unit in the hospital where the patient P is physically present.

Among other things, this arrangement allows the patient P, in a case where the patient P is unable to go to an originally planned event in a school or trip because the patient P suddenly becomes ill and in other cases, to have an experience as if the patient P were in a house that is distant from a location where the patient P is physically present. With the electronic system 100 described herein, the patient P can have a real-life simulated experience as if the patient P shared the same space with a relative and others who are physically present in a remote location.

Moreover, the display unit 20 includes the projector 23 that projects a spatial image of the house that corresponds to the first real space, and the screen 22 that displays thereon the spatial image output from the projector 23, and stores a program that corrects the spatial image in accordance with properties of the screen 22 in the ROM of the control unit 25. Therefore, it is possible to make the spatial image on the part of the house (first real space) appear, without being bound by properties of the screen 22 installed in a room where the patient P is physically present, and to enhance a sense of presence.

Moreover, the smell acquisition unit 50 has the smell sensor 51 that detects a smell in the room in the house that corresponds to the first real space, and the smell generation unit 60 is configured to output a smell corresponding to the smell detected by the smell sensor 51 into a room for the patient P in the hospital. Therefore, it is possible to reproduce a situation having a greater sense of presence with not only the vision and the sense of hearing but also with the sense of smell, and further improve the level of satisfaction of the user (e.g., the patient P).

Moreover, the ambient air acquisition unit 70 has the thermometer 71 that measures an ambient temperature inside the room in the house that corresponds to the first real space, and the ambient air generation unit 80 includes the air-conditioner 81 that adjusts an ambient temperature in one room in the hospital where the patient P is physically present in accordance with the temperature measured by the thermometer 71. Therefore, similar to the above, by causing not only the vision and the sense of hearing but also the temperature sense and the like included in the sense of touch to resemble the actual location, it is possible to cause the patient P to feel a greater sense of presence.

Moreover, the ambient air acquisition unit 70 has the anemometer 72 that measures an ambient wind velocity in the room in the house that is the first real space, and the ambient air generation unit 80 includes the air-conditioner 81 that outputs a wind at a wind velocity measured by the anemometer 72 in one room of the hospital where the patient P is physically present. Therefore, similar to the above, by utilizing not only the vision and the sense of hearing but also the sense of touch, it is possible to cause the patient P to experience a sense of presence as if the patient P went to the actual location.

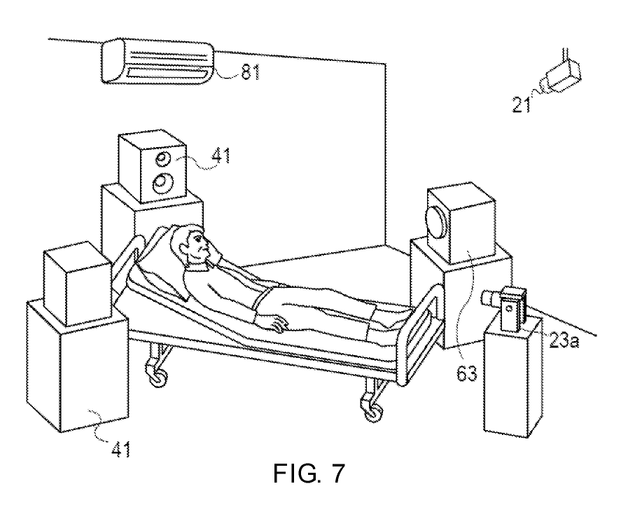

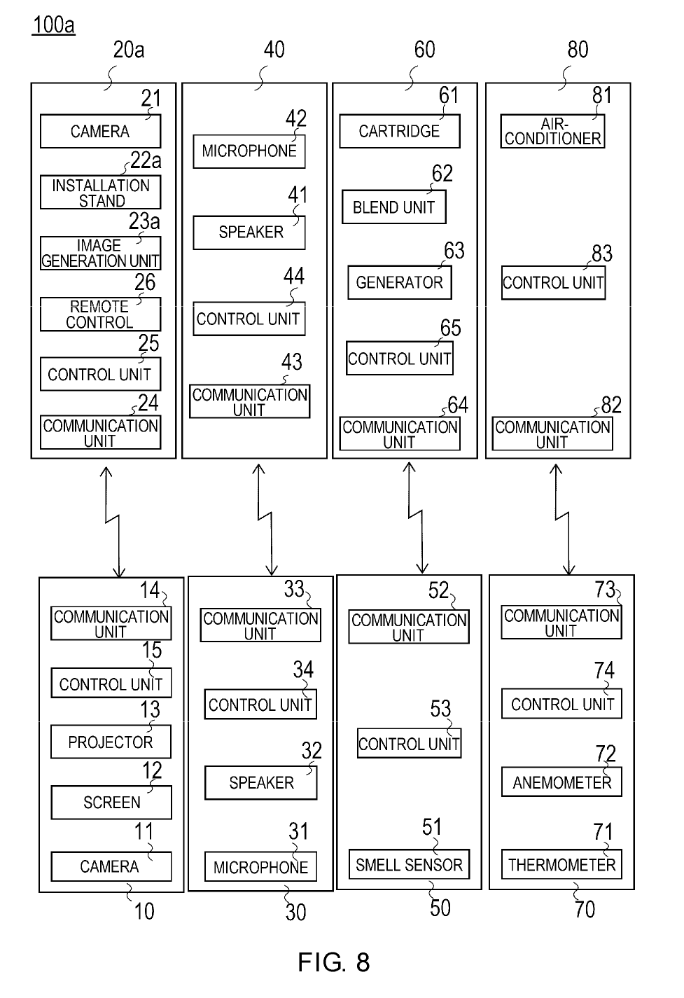

FIG. 7 illustrates an electronic system according to a second embodiment, and is a diagram illustrating a location that corresponds to a second real space where a user is physically present (e.g., a healing-space location). FIG. 8 is a block diagram illustrating the components associated with the electronic system according to the second embodiment. Although the display unit 20 in the first embodiment has been described as having the screen 22 and the projector 23, the following configuration may also, or alternatively, be employed. Note that, only the configuration of a display unit in the second embodiment may be different, and the other configurations may be similar, if not identical, to those in the first embodiment, so that explanations of the common configurations are omitted.

A display unit 20a in an electronic system 100a according to the second embodiment includes, as illustrated in FIG. 8, the camera 21, an installation stand 22a, an image generation unit 23a, the communication unit 24, the control unit 25, and the remote control 26. The camera 21, the communication unit 24, the control unit 25, and the remote control 26 are similar, if not identical, to those described in the first embodiment above, and thus explanations thereof are omitted.

The installation stand 22a may correspond to a base that is made of metal and is installed in a space where the patient P is physically present, especially within a photographed region range of the camera 21 and the image generation unit 23a, and may be installed on the ground in the space where the patient P is physically present. Electronic devices such as the camera 21 and the image generation unit 23a may be installed on the installation stand 22a. The installation stand 22a may correspond to the installation unit described herein.

The image generation unit 23a may be installed facing the patient P, and includes an irradiation device that emits semiconductor laser and the like, a galvanometer mirror that reflects the irradiated laser toward retinas of the patient P, and the like. The image generation unit 23a modulates the laser so as to be video signals of the relative and others photographed by the spatial image acquisition unit 10 with the abovementioned configuration, and emits the laser while scanning the laser in the retinas of the patient P, thereby generating a spatial image in the retinas of the patient P.

Here, “facing” in the image generation unit 23a indicates that the position and/or the direction of the image generation unit 23a is adjusted so as to allow an object part in the patient P to be photographed.

The image generation unit 23a in the second embodiment may correspond to the projector 23 in the first embodiment, and the operation of the electronic system 100a is similar, if not identical, to that described in the first embodiment above, therefore, an explanation using any additional sequence diagram and/or flowchart is unnecessary and is omitted.

The display unit 20a of the electronic system 100a in the second embodiment is configured to include the installation stand 22a and the image generation unit 23a. The installation stand 22a is installed in one room in a hospital where the patient P is physically present, the image generation unit 23a is installed on the installation stand 22a and generates or emits laser light with which the first real spatial image photographed in a house where the relative and others are present is generated for viewing by the patient P (e.g., generated in the retinas of the patient P, etc.).

Accordingly, the patient P does not need to wear a wearing type instrument such as eyeglasses in order to perceive a video from a distant location. This approach can prevent a condition such as a pressure ulcer from occurring on the ear or the like of the patient P, which is a site on which the eyeglass-type instrument is worn for a long period of time. Moreover, without the use of contacting eyeglass-type instruments the laser light video approach can prevent the infection in the same room and the like from spreading, in the hospital and the like.

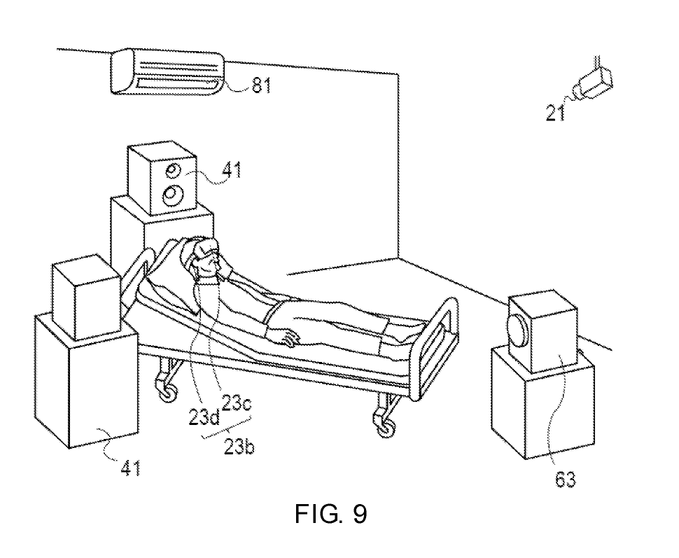

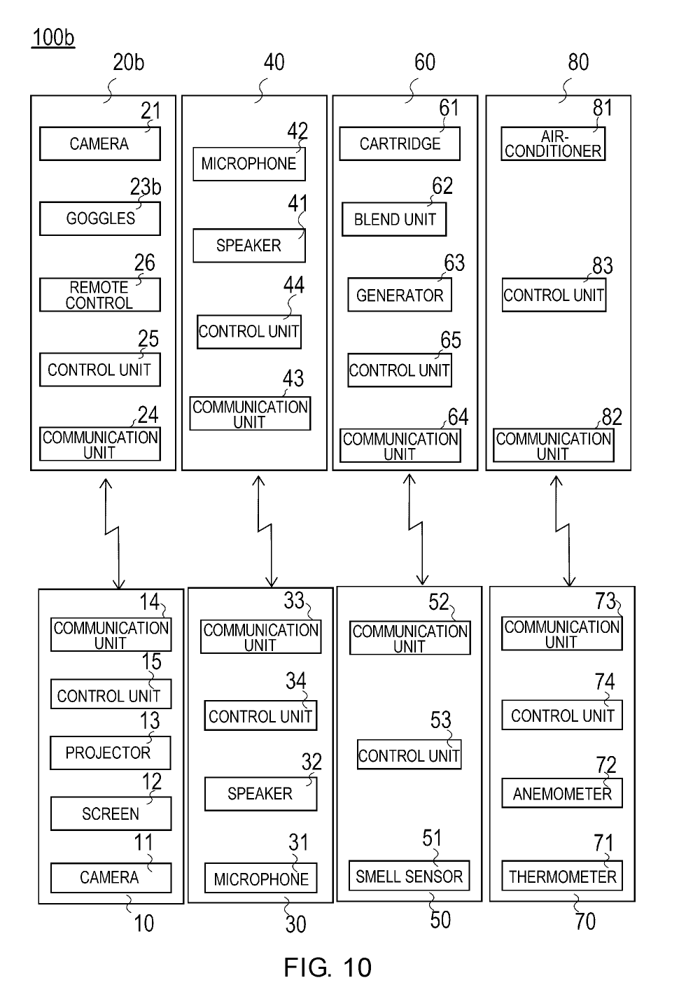

FIG. 9 illustrates an electronic system according to a third embodiment, and is a diagram illustrating a location that corresponds to a second real space where a user (e.g., a patient P) is physically present. FIG. 10 is a block diagram illustrating the components associated with the electronic system according to the third embodiment. Such explanations have been made that the display unit 20 uses the projector 23 and the screen 22 to project a video in the first embodiment, and that the image generation unit 23a generates a spatial image of the house in the retinas of the patient P in the second embodiment. However, the display unit can be also configured as follows. Note that, only the configuration of the display unit in the third embodiment is different, and the other configurations are similar to those in the first embodiment and/or in the second embodiment, so that the common explanations are omitted.

A display unit 20b in an electronic system 100b according to the third embodiment includes, as illustrated in FIG. 10, the camera 21, goggles 23b, the communication unit 24, the control unit 25, and the remote control 26. The camera 21, the communication unit 24, the control unit 25, and the remote control 26 are similar to those described in the first embodiment above, and thus the common explanations thereof are omitted.

The goggles 23b are an eyeglass-type instrument, and include, as illustrated in FIG. 9, a projection surface 23c that projects a video and corresponds to lens parts in the eyeglasses, and an attachment portion 23d that extends from both right and left ends of a display surface to the ears or the like of the patient P, and is worn on parts of the body, such as ears. The control unit 25 performs image processing of video data photographed by the camera 11, and projects the video data onto the projection surface 23c. Although the attachment portion 23d as described herein may include a rubber or elastic band, the attachment portion 23d only needs to allow the goggles 23b to be attached to the patient P, and may include arms (temples) for eyeglasses, instead of the above. The goggles 23b are configured as described herein to allow the patient P who wears the goggles 23b to perceive the spatial image and the like in the room in the house where the relative and others are present from the projection surface 23c of the goggles 23b.

The goggles 23b in the third embodiment may correspond to the projector 23 in the first embodiment and the image generation unit 23a in the second embodiment, and the operation of the electronic system 100b is substantially similar, if not identical, to that described in the first embodiment, therefore, an explanation using any additional sequence diagram and/or flowchart is unnecessary and is omitted.

As described above, the display unit 20b in the electronic system 100b according to the third embodiment includes the projection surface 23c onto which a first real spatial image is projected, and the attachment portion 23d that extends from both right and left ends of the projection surface 23c and is worn on the head (e.g., ears, etc.) or the like of the patient P who is physically present in one room in the hospital, which corresponds to the second real space. Therefore, it is possible to relatively easily perceive a first real spatial image where the relative and others are present, using a head-mounted display similar to VR headsets and/or goggles used in gaming.

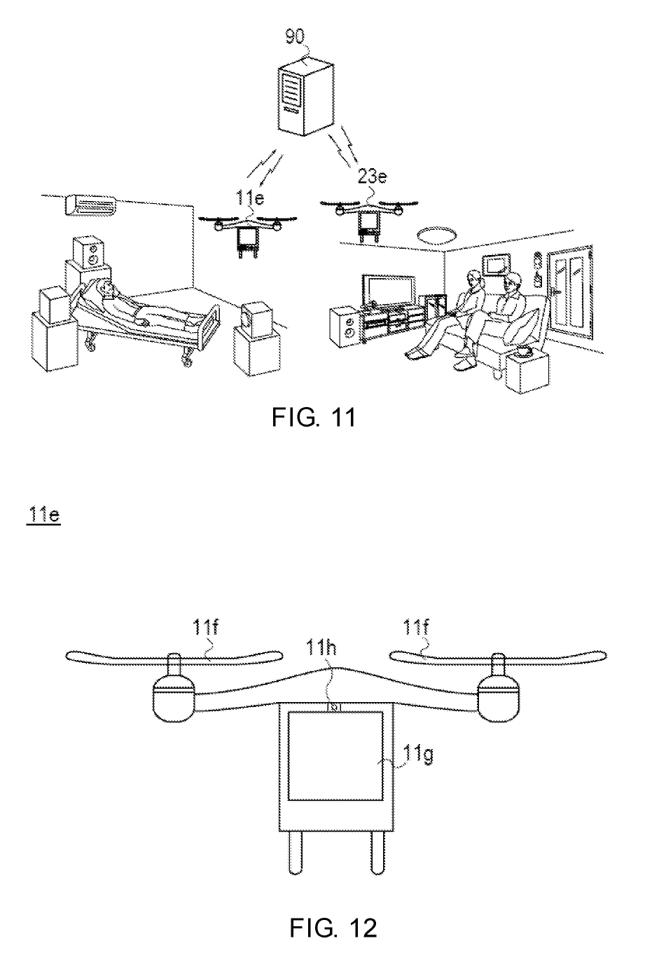

Note that, the present disclosure is not limited only to the specific embodiments described herein, but various changes are possible within the scope of the present disclosure. FIG. 11 is a diagram of an embodiment of the electronic system that utilizes an unmanned aerial vehicle for the transmission and reception of data. FIG. 12 is a schematic diagram illustrating the unmanned aerial vehicle of FIG. 11. The embodiments in which the camera 11 photographs a relative and others, and the projector 23, the image generation unit 23a, or the goggles 23b performs the display to the patient P have been described, but are not limited thereto.

In addition to the above, as illustrated in FIG. 11, such a configuration may be employed that an unmanned aerial vehicle 11e and an unmanned aerial vehicle 23e each having a camera function to photograph a spatial image and a display function to display a video or an image transmitted from the remote location may perform communication about spatial images between the house and the hospital.

The unmanned aerial vehicle 11e may include a motor, an actuator, gears, a sensor, and other components so as to allow autonomously flying, and has installed hardware necessary for wireless communication and installed hardware that detects positional information of the unmanned aerial vehicle 11e, such as GPS.

Rotor blades 11f may be provided on upper portions of the unmanned aerial vehicle 11e as illustrated in FIG. 12. These rotor blades 11f allow the unmanned aerial vehicle 11e to move in the vertical direction and in the horizontal direction with drive system components such as the motor, the actuator, and the like, and also allow hovering and the like. A display 11g is provided on a main body portion of the unmanned aerial vehicle 11e, and a camera 11h that photographs a space where the unmanned aerial vehicle 11e is physically present is mounted above the display 11g. The unmanned aerial vehicle 23e may have a similar, if not identical, configuration as that of the unmanned aerial vehicle 11e, and thus an explanation thereof is omitted.

A server 90 manages position information of the unmanned aerial vehicles 11e and 23e, collected data, and the like. A relay device such as a modem, a terminal adapter, and a gateway performs communication between the unmanned aerial vehicles 11e and 23e and the server 90. The communication network may be constructed using a TCP/IP protocol to mutually connect various telecommunication lines (public lines such as a telephone line, an ISDN line, an ADSL line, and an optical line, a dedicated line, and the like). The remote control 26 performs an instruction of a start, a stop, movement, or the like to the unmanned aerial vehicle 11e.

This configuration also enables the patient P to experience a sense of presence as if the patient P were in the house that is distant from the hospital where the patient P is physically present.

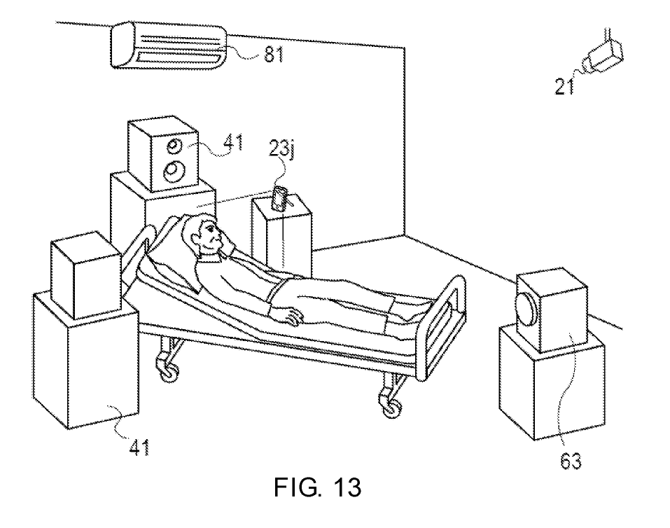

FIG. 13 illustrates a modification of the electronic system in accordance with embodiments of the present disclosure, and is a diagram illustrating a case where a portable device may be used for displaying a spatial image in a remote location with respect to a user. In the first embodiment, the embodiment in which the projector 23 is used to display the spatial image of the relative and others to the patient P has been described, however, the disclosure is not so limited. In addition to the above, in place of the projector 23, as illustrated in FIG. 13, a portable terminal 23j or communication device, such as a smartphone, tablet, personal computer, etc., having a display function may be used to provide display functions associated with the embodiments of the electronic system described herein.

Moreover, in the first embodiment, a temperature in a space where the relative and others are physically present may be measured by the thermometer 71, and a temperature in a space where the patient P is physically present may be adjusted by the air-conditioner 81 in accordance with the temperature measured by the thermometer 71 has been described. However, the embodiments of the present disclosure are not so limited. For instance, the embodiments of the electronic system may be configured in such a manner that a hygrometer is provided in addition to the thermometer 71, humidity data obtained by the hygrometer is transmitted, and the humidity (e.g., percentage of water in the air) inside the room where the patient P is physically present may be adjusted by the air-conditioner 81 (e.g., increasing or decreasing the percentage of water in the air).

Moreover, in some embodiments, the smell generation unit 60 is described as generating the smell detected by the smell acquisition unit, but embodiments of the present disclosure are not so limited. Such a configuration may be employed that the control unit 65 of the smell generation unit 60 stores data on an object that can generate a smell from the data acquired by the spatial image acquisition unit 10 and an image recognition program, in the ROM. Stated another way, the electronic system 100 may identify an object (e.g., based on image data provided by the spatial image acquisition unit 10) and determine whether a stored odor output is associated with the identified object. In response, the smell generation unit 60 may emit the stored odor output corresponding to the smell of the identified object. In some embodiments, a smell may be output on the basis of preregistered data on the object that can generate a smell from the data recognized by the image recognition and a detection result by the smell sensor 51. Such a configuration allows the smell in the remote location where the relative and others are present to be reproduced in the space where the patient P is physically present with higher accuracy than a case where only the smell sensor 51 is used.

Although described as comprising a number of control units 15, 25, 34, 44, 53, 65, 74, 83, it should be appreciated that the functionality associated with the control of the various units 10, 20, 30, 40, 50, 60, 70, 80 of the electronic system 100 may be controlled by two control units (e.g., with a first control unit located in the first real space controlling one or more of the first set of units 10, 30, 50, 70 in the first real space and a second control unit located in the second real space controlling one or more of the second set of units 20, 40, 60, 80 in the second real space, etc.), or fewer control units than have been illustrated and described above. Similarly, the electronic system 100 is described as comprising a number of communication units 14, 24, 34, 43, 52, 64, 73, 82, the functionality of which may be performed by two communication units (e.g., with a first communication unit located in the first real space providing communications for one or more of the first set of units 10, 30, 50, 70 in the first real space and a second communication unit located in the second real space providing communications for one or more of the second set of units 20, 40, 60, 80 in the second real space, etc.)

### DESCRIPTION OF REFERENCE CHARACTERS

10 spatial image acquisition unit
20, 20a, 20b display unit
22 screen (projection unit)
22a installation stand (installation unit)
23 projector (video output unit)
23a image generation unit
23b goggles
23c projection surface
23d attachment portion
25 control unit (correction unit)
30 audio acquisition unit
40 audio output unit
50 smell acquisition unit
51 smell sensor (detection unit)
60 smell generation unit
70 ambient air acquisition unit
71 thermometer (measurement unit)
72 anemometer (different measurement unit)
80 ambient air generation unit
81 air-conditioner (blowing unit, adjustment unit)
90 server
100, 100a, 100b electronic system

What is claimed is:

1. An electronic system comprising:
a spatial image acquisition unit that acquires a first real spatial image that is visually perceived in a predetermined first real space;
a display unit that virtually displays the first real spatial image acquired by the spatial image acquisition unit, in a second real space that is distant from the first real space;
a spatial information acquisition unit that acquires first real spatial information that is different from the first real spatial image and perceived by any of five senses other than vision, in the first real space; and
a reproduction unit that reproduces the first real spatial information acquired by the spatial information acquisition unit, in the second real space.

2. The electronic system according to claim 1, wherein the display unit comprises:
a video output unit that projects the first real spatial image;
a projection unit having a projection surface on which the first real spatial image output from the video output unit is displayed; and
a correction unit that corrects the first real spatial image in accordance with properties of the projection surface.

3. The electronic system according to claim 1, wherein the display unit comprises:
an installation unit that is mounted in the second real space; and
an image generation unit that is installed on the installation unit and generates laser light with which the first real spatial image is generated for viewing by a person who is physically present in the second real space.

4. The electronic system according to claim 1, wherein the display unit comprises:
a projection surface onto which the first real spatial image is projected; and
an attachment portion that extends from both ends of the projection surface and is to be attached to a part of a body of the person who is physically present in the second real space.

5. The electronic system according to claim 1, wherein
the spatial information acquisition unit comprises a detection unit that detects an ambient smell in the first real space, and
the reproduction unit outputs a substance corresponding to the smell detected by the detection unit, into the second real space.

6. The electronic system according to claim 1, wherein
the spatial information acquisition unit comprises a measurement unit that measures an ambient temperature and/or an ambient humidity in the first real space, and
the reproduction unit comprises an adjustment unit that adjusts an ambient temperature and/or an ambient humidity in the second real space in accordance with a measurement result by the measurement unit.

7. The electronic system according to claim 1, wherein
the spatial information acquisition unit comprises a different measurement unit that measures an ambient wind velocity in the first real space, and
the reproduction unit includes a blowing unit that outputs air at the wind velocity measured by the different measurement unit, in the second real space.

8. An electronic real-life simulation treatment system, comprising:
a camera disposed in a first real space, wherein the camera acquires video data about an environment of the first real space;
a spatial information acquisition unit disposed in the first real space, the spatial information acquisition unit comprising:
a microphone that detects sounds in the environment of the first real space;
an electronic odor sensor that detects scents in the environment of the first real space; and
an ambient air acquisition unit that measures ambient air conditions in the environment of the first real space comprising at least one of a temperature, a wind velocity, and a humidity; and
a communication unit that sends, across a communication network, the video data and information about the detected sounds, the detected scents, and the ambient air conditions in the environment of the first real space to a receiving communication unit in a second real space that is different and remotely located from the first real space, wherein, in response to receiving the video data and information a display unit disposed in the second real space is caused to output the video data and a reproduction unit disposed in the second real space is caused to reproduce the detected sounds, the detected scents, and the ambient air conditions in an environment of the second real space.

9. The electronic real-life simulation treatment system of claim 8, further comprising:
a display device disposed in the second real space that renders the video data acquired by the camera to a surface in the second real space in real time.

10. The electronic real-life simulation treatment system of claim 9, further comprising:
a reproduction unit disposed in the second real space comprising:
a speaker that outputs sounds substantially matching the detected sounds received via the microphone;
a scent generation unit that outputs scents substantially matching the detected scents received via the electronic odor sensor; and
an air-conditioner that outputs air that substantially matches the ambient air conditions received via the ambient air acquisition unit.

11. The electronic real-life simulation treatment system of claim 10, wherein the second real space is a room of a hospital associated with a patient, and wherein the first real space is a room of house associated with a relative of the patient.

12. The electronic real-life simulation treatment system of claim 11, wherein the display device is a projector, and wherein the video data is rendered to a wall in the room of the hospital.

13. The electronic real-life simulation treatment system of claim 12, wherein the sounds in the environment of the first real space comprise sounds emitted by a person and sounds of the environment of the first real space other than the sounds emitted by the person.

14. The electronic real-life simulation treatment system of claim 10, wherein the scent generation unit comprises:
a cartridge containing smells of food, drink, and objects;
a blend unit that mixes a plurality of the smells in the cartridge; and
a fan that emits the mixed plurality of the smells in the cartridge from the scent generation unit.

15. The electronic real-life simulation treatment system of claim 10, wherein the ambient air acquisition unit comprises:
a digital thermometer that measures the temperature of the environment of the first real space; and
an anemometer that measures the wind velocity of the environment of the first real space.

16. A method, comprising:
acquiring, via a camera disposed in a first real space, a first real spatial image of an area of the first real space, wherein the first real spatial image comprises video data;
transmitting, across a communication network via a communication unit, the first real spatial image to a receiving communication unit in a second real space, wherein the second real space is different and remotely located from the first real space;
displaying, via an image projector disposed in the second real space, the first real spatial image to a surface in the second real space as the first real spatial image is received from the communication unit;
acquiring, via a spatial information acquisition unit disposed in the first real space, first real spatial information comprising sound data and at least one of odor data, temperature data, and wind speed data measured in the first real space;
transmitting, across the communication network via the communication unit, the first real spatial information to the receiving communication unit in the second real space; and
outputting, in response to receiving the first real spatial information, the sound data via a speaker disposed in the second real space and at least one of a reproduced odor in the second real space based on the odor data, a reproduced temperature in the second real space based on the temperature data, and a reproduced air output in the second real space based on the wind speed data.

17. The method of claim 16, wherein the surface in the second real space is a wall of a healing-space room for a patient undergoing treatment, wherein the first real space is a room of a house of a relative of the patient undergoing treatment, and wherein the sound data and the at least one of the reproduced odor, the reproduced temperature, and the reproduced air is output in the second real space in real time.

18. The method of claim 17, wherein an air-conditioner outputs at least one of air at a temperature that substantially matches the temperature data and air at a wind speed that substantially matches the wind speed data.

19. The method of claim 17, wherein prior to acquiring the first real spatial image of the area of the first real space, the method comprises:
determining that a connection request is made by the patient via a first activation of a remote control in the second real space.

20. The method of claim 19, further comprising:
determining, after the connection request is made, that a disconnection request is made by the patient via a second activation of the remote control in the second real space; and
ceasing, in response to determining the disconnection request is made, display of the first real spatial image, output of the sound data, and output of the at least one of the reproduced odor, the reproduced temperature, and the reproduced air.
